(19) United States
(12) Patent Application Publication
(10) Pub. No.: US 2008/0002407 A1
(43) Pub. Date: Jan. 3, 2008

(54) Light emitting module for automatically adjusting lighting power and a method thereof

(76) Inventor: Jan J. Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/475,977

(22) Filed: Jun. 28, 2006

(51) Int. Cl. F21V 23/04

(52) U.S. Cl. 362/276

(57) ABSTRACT

A light emitting module for automatically adjusting the lighting power includes a light emitting diode module and a power control board. The power control board is electrically connected with the light emitting diode module. The power control board further includes a power converting unit and a thermal sensing unit. The thermal sensing unit detects the environmental temperature to generate a measured signal of temperature. The power converting unit converts the first power into a second power to output according to the measured temperature from the thermal sensing unit. Thereby, the lighting power of the light emitting module is automatically adjusted. When the temperature is high, the lighting power is decreased to lower the temperature. When the temperature is low, the lighting power is increased.

### BACKGROUND OF THE INVENTION

1. Field of the Invention

The present invention relates to a light emitting module. In particular, this invention relates to a light emitting module for automatically adjusting the lighting power and a method thereof.

2. Description of the Related Art

Due to the development of light emitting diodes, high-brightness and high-power light emitting diodes (HB/HP LED) have been applied to a variety of devices. Comparing with convectional lamps, high-brightness and high-power light emitting diodes have a number of characteristics, such as low power consumptions, long usage life, fast response, etc. High-power light emitting diodes can be applied to household lamps, commercial lamps, LCD backlight modules, and car lamps. The high-brightness light emitting diodes can be applied to cell phones, digital still cameras, advertising billboards, and traffic signals.

When an LED is driven, most supplied power is converted into heat and only few supplied power is converted into light. Therefore, how to design a circuit keeping good power efficiency is a key factor, especially for high-power light emitting diodes that consume a lot of power. However, an LED has to be operated under a specified operating temperature. When heat is not conducted to its outside well and LEDs are operated in high temperature environments for a long time, LED's lighting power is decayed gradually so that the light emitting efficiency decreases and the usage life thereof shortens. How to conduct heat to the outside is another key factor.

In the prior art, in order to conduct heat to the outside well for a light emitting module using an LED as the light source, the total heat is evaluated in advance and heat-conducting materials (such as heat sinks) are installed on the light emitting module. Due to this design, the dimension of light emitting module increases. The prior art cannot simultaneously achieve a good lighting efficiency, a small dimension, and conduct heat well. The prior art uses heat-conducting materials to conduct heat. It is passive. It only conducts heat according to the characteristic of the heat-conducting materials. It cannot be automatically adjusted according to the temperature of the LED. Meanwhile, the over-heating problem still exists.

### SUMMARY OF THE INVENTION

One particular aspect of the present invention is to provide a light emitting module that automatically adjusts the lighting power of the light emitting module according to the LED's environmental temperature. By adjusting the lighting power of the light emitting module, the generated heat and the conducting heat are kept in balance to maintain the brightness and protect the LED.

The light emitting module for automatically adjusting the lighting power includes a light emitting diode module and a power control board. The light emitting diode module further includes a metal substrate and a LED die. The power control board is electrically connected with the light emitting diode module, and the power control board further includes a power converting unit and a thermal sensing unit. The power converting unit receives a first power, and converts the first power into a second power to output. The thermal sensing unit is electrically connected with the power converting unit and detects the environmental temperature to generate a corresponding temperature signal via leaning the thermal sensing unit on the metal substrate of the light emitting diode module. The power converting unit converts the first power into the second power and outputs the second power according to the temperature measured by the thermal sensing unit. Thereby, the lighting power is automatically adjusted.

The present invention also provides a method for automatically adjusting the lighting power of a light emitting module. The steps includes receiving a first power and generating a measured signal of temperature according to the environmental temperature, converting the first power into a second power according to the measured temperature, and adjusting the lighting power of the light emitting module via adjusting the second power.

The thermal sensing unit can be a thermistor having a negative temperature coefficient (NTC). It utilizes the characteristic of being sensitive to temperature, and the higher the temperature is, the lower the resistance is. The NTC thermistor generates a resistance that changes to low as the temperature changes to high.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the light emitting module for automatically adjusting the lighting power of the present invention;

FIG. 2 is an exploded perspective view of the light emitting module for automatically adjusting the lighting power of the present invention;

FIG. 3 is a block diagram of the light emitting module for automatically adjusting the lighting power of the preferred embodiment of the present invention;

FIG. 4 is a flow chart of the light emitting module for automatically adjusting the lighting power of the preferred embodiment of the present invention; and

FIG. 5 is a circuit diagram of the power control board of the present invention.

### DETAILED DESCRIPTION OF THE PREFERRED EMBODIMENTS

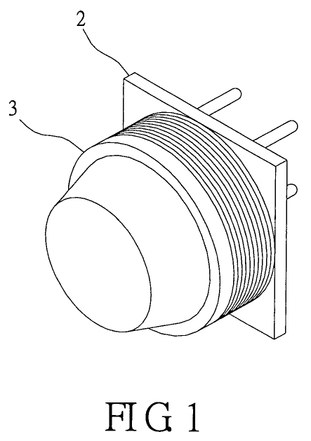

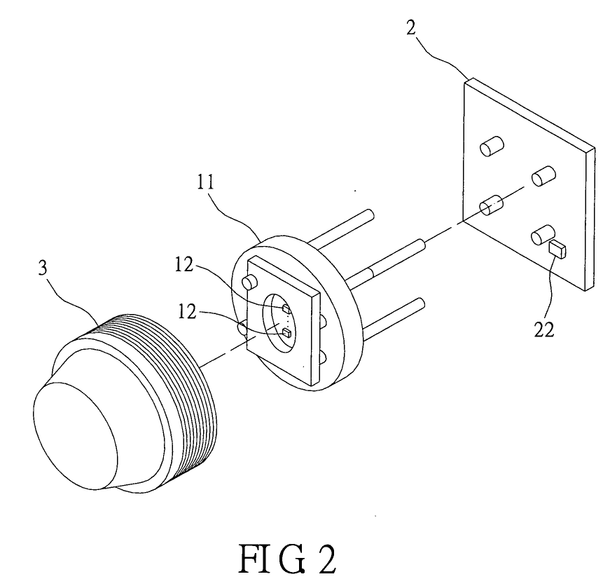

Reference is made to FIGS. 1 and 2, which show a schematic diagram and an exploded perspective view of the light emitting module for automatically adjusting the lighting power of the present invention. The light emitting module includes a light emitting diode module 1, a power control board 2, and an external tube 3. The light emitting diode module 1 is wrapped by the external tube 3 and is electrically connected with the power control board 2. The light emitting diode module 1 includes at least one light emitting diode die 12 attached on a metal substrate 11. The power control board 2 includes a thermal sensing unit 22. When the power control board 2 is assembled with the light emitting diode module 1, the thermal sensing unit 22 leans on the metal substrate 11 to detect the environmental temperature of the light emitting diode die 12 and generate a measured signal of temperature. Therefore, the lighting power of the light emitting module is automatically adjusted.

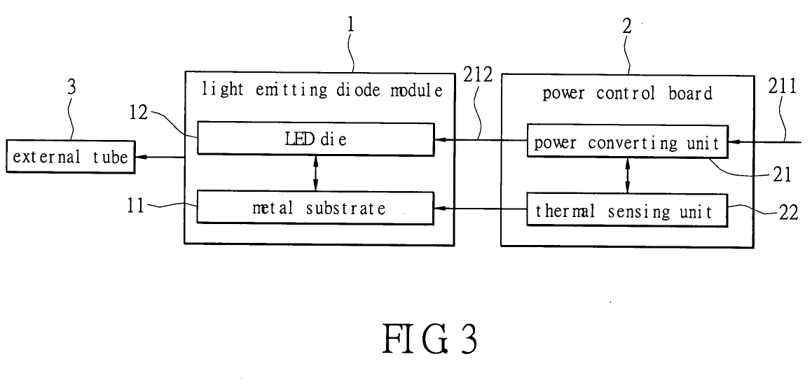

Reference is made to FIG. 3, which shows a block diagram of the light emitting module for automatically adjusting the lighting power of the preferred embodiment of the present invention. The light emitting module for automatically adjusting the lighting power of the present invention includes a light emitting diode module 1, a power control board 2, and an external tube 3.

The light emitting diode module 1 further includes a metal substrate 11 and at least one LED die 12, and the light emitting diode module 1 is wrapped by the external tube 3. The LED die 12 is attached to the metal substrate 11. The metal substrate 11 is made of metal, such as a copper substrate or an aluminum substrate. The outer surface of the external tube also can be made of metal, such as copper or aluminum.

The power control board 2 is electrically connected with the light emitting diode module 1. The power control board 2 further includes a power converting unit 21 and a thermal sensing unit 22. The thermal sensing unit 22 is electrically connected with the power converting unit 21 and detects the temperature that is affected by the heat produced from the LED die 12 attached to the metal substrate 11 or the environmental temperature to generate a corresponding measured signal of temperature via leaning the thermal sensing unit 22 on the metal substrate 11 of the light emitting diode module 1. The power converting unit 21 receives a first power 211 and converts the first power 211 into a second power 212 to output according to the measured signal of temperature from the thermal sensing unit 22. Thereby, the lighting power of the light emitting module is automatically adjusted according to the measured temperature. When the light emitting module is operated at a high temperature, the lighting power is lowered. When the light emitting module is operated at a low temperature, the lighting power is increased. The thermal sensing unit 22 can be a thermistor, a thermal diode, or a thermal couple. The thermistor is a thermal resistor having a negative temperature coefficient, and its package can be an SMT or a DIP.

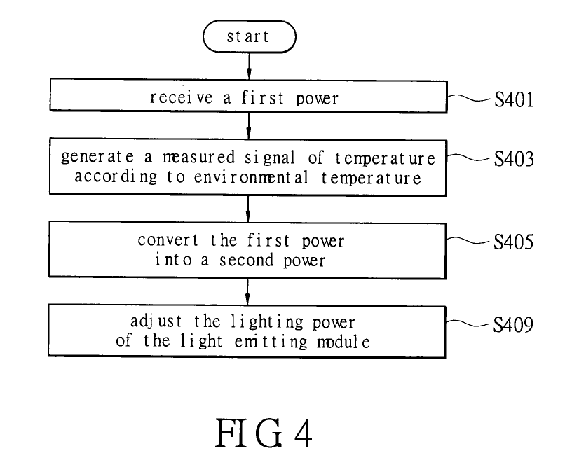

Reference is made to FIG. 4, which shows a flow chart of the light emitting module for automatically adjusting the lighting power of the preferred embodiment of the present invention. First, the method receives a first power 211 (S401). Second, a measured temperature signal is generated according to the environmental temperature of the LED die 12 (S403). It is implemented by detecting the environmental temperature to generate the measured signal of temperature via leaning the thermal sensing unit 22 on the metal substrate 11 of the light emitting diode module 1. The thermal sensing unit 22 can be a thermistor having a negative temperature coefficient (NTC), a thermal diode, or a thermal couple, etc. Its package can be an SMT or a DIP. The environmental temperature is affected by the heat generated from the LED die 12 or the external environmental temperature.

Next, a power converting unit 21 converts the first power 211 into a second power 212 according to the measured signal of temperature (S405). Finally, the lighting power of the light emitting module is automatically adjusted according to the second power 212 (S409).

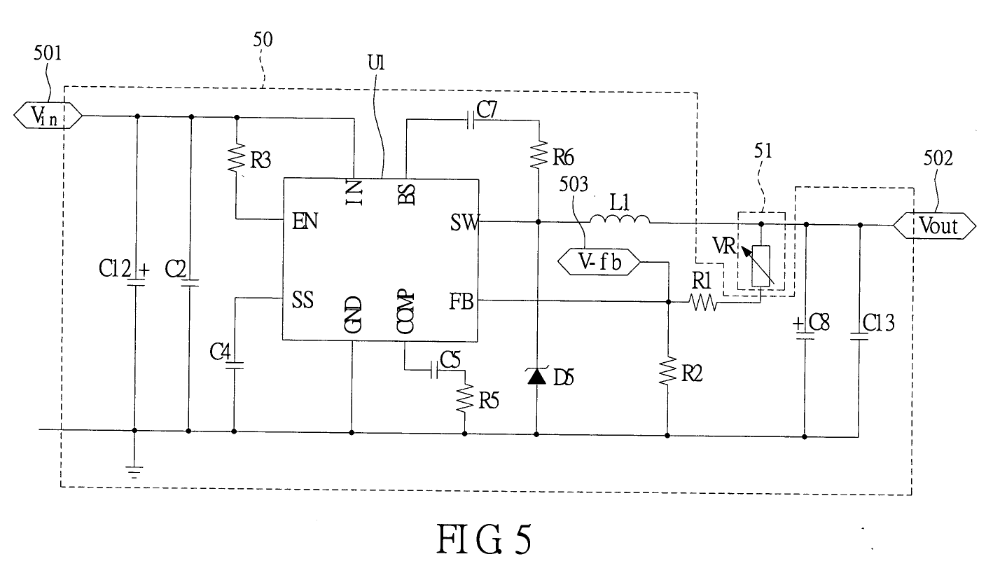

Reference is made to FIG. 5, which shows a circuit diagram of the power control board of the present invention. As shown in the figure, a step-down converting circuit 50 is composed of a step-down converter U1 and other relative circuits. The step-down converting circuit 50 cooperates with a NTC thermistor having a negative temperature coefficient 51 to convert the input voltage 501 into the step-down voltage 502 to output. The step-down converter U1 adjusts the step-down voltage 502 according to a voltage-dividing principle. The NTC thermistor 51 detects the environmental temperature and automatically changes its resistance to generate a feedback voltage 503 for adjusting the step-down voltage 502 outputted from the step-down converter U1. Therefore, by changing the step-down voltage 502, the lighting power of the LED die 12 is automatically adjusted.

The resistance value of the NTC thermistor 51 has to make the minimum step-down voltage 502 outputted from the step-down converter U1 to drive the LED die 12 and make the operating of the LED die 12 stay under a specified operating temperature. When the measured temperature detected by the NTC thermistor 51 is higher than an upper limit, a lowest step-down voltage 502 is supplied to make a lighting power of the LED die 12 be lowered to a minimum value, and then the temperature is lowered. When the measured temperature detected by the NTC thermistor 51 is low, the NTC thermistor 51 increases its resistance and outputs a higher step-down voltage 502 to increase the lighting power of the LED die 12.

The present invention utilizes the characteristic of the thermal sensing unit 22 being sensitive to the temperature to automatically adjust the lighting power of the light emitting module. When the temperature is high, the lighting power is decreased to lower the temperature and protect the LED die. When the temperature is low, the lighting power is increased.

The present invention has the following characteristics:

1. The dimension is decreased. The circuit can automatically reduce the lighting power. The present invention automatically reduces the lighting power to lower the operating temperature, and the present invention does not need to cooperate with the heat-conducting material having a large dimension. Therefore, the dimension of the light emitting module is reduced.

2. Brightness at night is increased. The environmental temperature also is a factor to affect the measured signal of temperature. When the temperature becomes lower at night, the power converting unit 21 provides more power to increase the lighting power of the light emitting module. Therefore, brightness at night is increased.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A light emitting module for automatically adjusting the lighting power, comprising:
a light emitting diode module; and
a power control board electrically connected with the light emitting diode module;
wherein the power control board further comprises:
a power converting unit receiving a first power and converting the first power into a second power to output; and
a thermal sensing unit electrically connected with the power converting unit for generating a measured signal of temperature;
wherein, the power converting unit converts the first power into the second power and outputs the second power according to the measured signal of temperature from the thermal sensing unit for adjusting the lighting power.

2. The light emitting module for automatically adjusting the lighting power as claimed in claim 1, wherein the light emitting diode module further comprises:
a metal substrate; and
at least one LED die attached to the metal substrate.

3. The light emitting module for automatically adjusting the lighting power as claimed in claim 2, wherein the metal substrate is a copper substrate or an aluminum substrate.

4. The light emitting module for automatically adjusting the lighting power as claimed in claim 1, wherein the thermal sensing unit leans on the metal substrate of the light emitting diode module.

5. The light emitting module for automatically adjusting the lighting power as claimed in claim 1, wherein the thermal sensing unit is a thermistor, a thermal diode, or a thermal couple.

6. The light emitting module for automatically adjusting the lighting power as claimed in claim 5, wherein the thermistor is a thermal resistor having a negative temperature coefficient (NTC).

7. The light emitting module for automatically adjusting the lighting power as claimed in claim 5, wherein the package of the thermistor is an SMT or a DIP.

8. The light emitting module for automatically adjusting the lighting power as claimed in claim 1, further comprising:
an external tube wrapped around the light emitting diode module.

9. The light emitting module for automatically adjusting the lighting power as claimed in claim 8, wherein the outer surface of the external tube is made of copper or aluminum.

10. A method for automatically adjusting the lighting power of a light emitting module, comprising:
receiving a first power;
detecting an environmental temperature to generate a measured signal of temperature;
converting the first power into a second power according to the measured signal of temperature; and
adjusting automatically the lighting power of the light emitting module via adjusting the second power.

11. The method for automatically adjusting the lighting power of a light emitting module as claimed in claim 10, wherein the environmental temperature is affected by the heat generated from the at least one LED die.

12. The method for automatically adjusting the lighting power of a light emitting module as claimed in claim 10, wherein the environmental temperature of LED is affected by an external environmental temperature.

13. The method for automatically adjusting the lighting power of a light emitting module as claimed in claim 10, wherein the step of detecting an environmental temperature to generate a measured signal of temperature is implemented by leaning a thermal sensing unit on a metal substrate of a light emitting diode module.

14. The method for automatically adjusting the lighting power of a light emitting module as claimed in claim 13, wherein the thermal sensing unit is a thermistor, a thermal diode, or a thermal couple.

15. The method for automatically adjusting the lighting power of a light emitting module as claimed in claim 14, wherein the thermistor is a thermal resistor having a negative temperature coefficient

16. The method for automatically adjusting the lighting power of a light emitting module as claimed in claim 14, wherein the package of the thermistor is an SMT or a DIP.
